(19) United States
(12) Patent Application Publication
(10) Pub. No.: US 2016/0108876 A1
(43) Pub. Date: Apr. 21, 2016

(54) OIL FILTER

(71) Applicant: Caterpillar Inc., Peoria, IL (US)

(72) Inventor: Derek L. Waldschmidt, Peoria, IL (US)

(73) Assignee: Caterpillar Inc., Peoria, IL (US)

(21) Appl. No.: 14/979,601

(22) Filed: Dec. 28, 2015

(51) Int. Cl. F02M 59/44; F02M 37/22

(52) U.S. Cl. CPC F02M 59/44; F02M 37/22

(57) ABSTRACT

An oil filtration system including an oil reservoir and a first conduit assembly having a first end and a second end. The first conduit assembly being in fluid communication with the oil reservoir at the first end, and an HEUI pump at the second end. The first conduit assembly includes a first pump coupled to the first conduit assembly, and disposed downstream of the oil reservoir. The first pump adapted to pump oil from the oil reservoir to the first conduit assembly. A primary filter coupled to the first conduit assembly, and disposed downstream of the first pump. A bypass conduit disposed in parallel configuration with the primary filter, and adapted to provide a bypass path for flow of oil therethrough, thereby preventing flow of oil through the primary filter. A secondary filter coupled downstream to both the first conduit assembly and the bypass conduit, and disposed upstream of HEUI pump.

### TECHNICAL FIELD

The present invention relates to an oil filter, and more specifically, to an oil filter for a Hydraulically actuated, Electronically controlled Unit Injector (HEUI) pump.

### BACKGROUND

Heavy machines such as cold planers are provided with internal combustion engines that use Hydraulically actuated, Electronically controlled Unit Injector (HEUI) systems in order to inject fuel into the engine. Such system includes an oil tank which supplies oil to a HEUI pump, which further pumps the oil for operating the Unit Injectors. Typically, moving components in the engine generate debris due to wear of the moving components. Such debris is introduced into the oil, which is used for operating the Unit Injectors. Generally, the HEUI system is provided with an oil filter in order to prevent the debris to enter the HEUI pump and subsequently, the fuel injectors during working of the engine.

Under low temperature conditions, the oil in the oil tank becomes highly viscous, and thus, the oil is unable to pass through the oil filter due to increased viscosity. Therefore, in order to start the engine, a bypass is provided in the oil filter, which provides an alternate path to the oil such that the oil does not pass through the oil filter in order to reach the HEUI pump for starting the engine. When the oil flows through the bypass, it is not filtered by the oil filter, and therefore, the debris flowing in the oil enter the HEUI pump, and further into the Unit Injectors. This causes damage to the HEUI pump and the Unit Injectors, eventually leading to failure of the HEUI system. In order to clear the debris, the HEUI pump needs to be serviced regularly increasing the operating costs of the machine. Further, a timely service of the Unit Injectors is also required, making the servicing of the HEUI system even more time consuming and costly. Therefore, there is a need for an oil filtration system which prevents the debris to enter the HEUI pump in low temperature conditions.

US patent application number 20140069874 discloses an oil filter assembly for an internal combustion engine, including a primary filter and a secondary filter. The secondary filter is disposed concentrically within the primary filter. A pressure actuated valve is provided in the oil filter assembly such that oil passes through the secondary filter only when there is a predetermined pressure differential across the pressure actuated valve, i.e. only when the primary filter becomes plugged. Such a filter assembly only provides a fail-safe mechanism that filters the oil when the primary filter is plugged. In such a filter assembly, the secondary filter is designed to operate at a higher pressure, making the filter assembly unsuitable for HEUI system under low temperature conditions. Moreover, the placement of secondary filter within the primary filter increases the complexity of the oil filtration system increasing the servicing costs. Therefore, there is a need for a filtration system which is less complex and suitable for filtering oil for a HEUI system.

### SUMMARY OF THE INVENTION

In one aspect of the present disclosure, an oil filtration system for a Hydraulically actuated Electronically controlled Unit Injector (HEUI) pump is provided. The oil filtration system includes an oil reservoir and a first conduit assembly. The first conduit assembly having a first end and a second end. The first conduit assembly being in fluid communication with the oil reservoir at the first end, and the first conduit assembly being in fluid communication with the HEUI pump at the second end. The first conduit assembly including a first pump coupled to the first conduit assembly, and disposed downstream of the oil reservoir. The first pump is adapted to pump oil from the oil reservoir to the first conduit assembly. A primary filter coupled to the first conduit assembly, and disposed downstream of the first pump. A bypass conduit disposed in parallel configuration with the primary filter, the bypass conduit adapted to provide a bypass path for flow of oil therethrough, thereby preventing flow of oil through the primary filter. A secondary filter coupled downstream to both the first conduit assembly and the bypass conduit and is disposed upstream of the HEUI pump.

Other features and aspects of this disclosure will be apparent from the following description and the accompanying drawings.

### BRIEF DESCRIPTION OF THE DRAWINGS

FIG. 1 is a system diagram of a Hydraulically actuated Electronically controlled Unit Injector (HEUI) system for an internal combustion engine, in accordance with the concepts of the present disclosure;

FIG. 2 is a schematic diagram of a lubrication system of the HEUI system of FIG. 1, in accordance with the concepts of the present disclosure;

FIG. 3 shows a front view and a side view of a primary filter of HEUI system of FIG. 1, in accordance with the concepts of the present disclosure; and

FIG. 4 shows a HEUI pump and a secondary filter of the lubrication system of FIG. 2, in accordance with an embodiment of the present disclosure.

### DETAILED DESCRIPTION

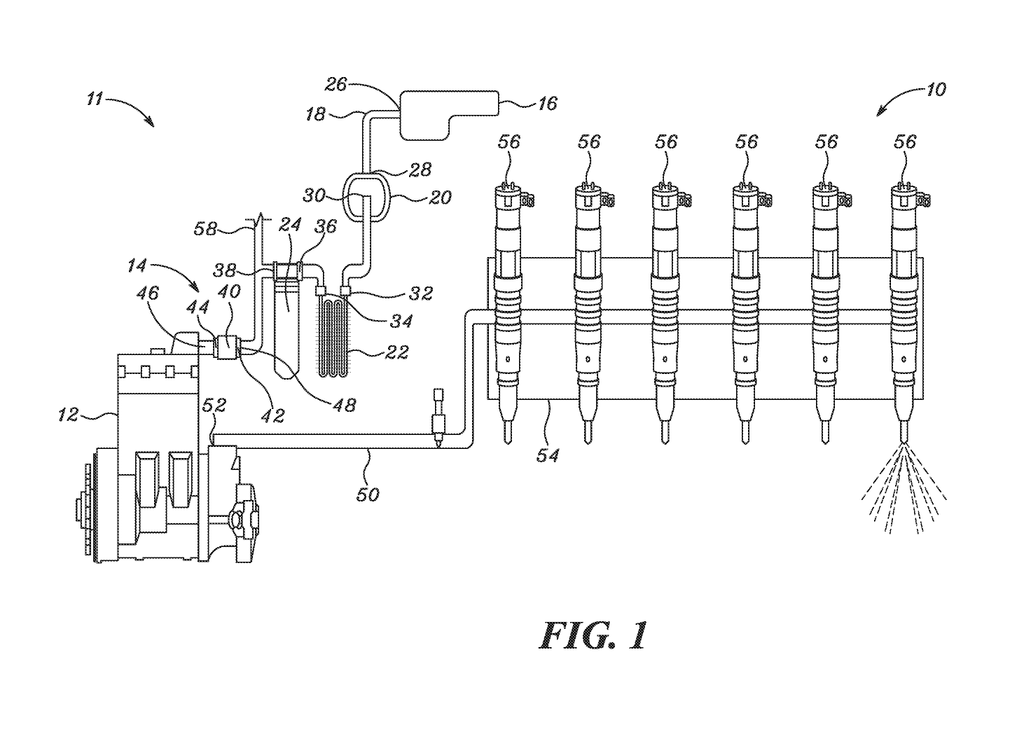

FIG. 1 is a diagram of a lubrication system 11 of a Hydraulically actuated Electronically controlled Unit Injector (HEUI) system 10. The lubrication system 11 includes a HEUI pump 12 and an oil filtration system 14 for filtering oil before introducing in the HEUI pump 12. The oil filtration system 14 includes an oil reservoir 16, and a first conduit assembly 18. The first conduit assembly 18 further includes a first pump 20, an oil cooler 22, and a primary filter 24. The oil reservoir 16 containing oil is coupled to a first end 26 of the first conduit assembly 18, and therefore, is in fluid communication with the first conduit assembly 18.

The first pump 20 is coupled to the first conduit assembly 18 and is disposed downstream of the oil reservoir 16. The first pump 20 includes an inlet 28 and an outlet 30, each coupled to the first conduit assembly 18. The first pump 20 pumps the oil contained in the oil reservoir 16 to the HEUI pump 12. The oil pumped by the first pump 20 passes through the outlet 30 and is received by the oil cooler 22 coupled to first conduit assembly 18 and disposed downstream of the first pump 20. The oil cooler 22 includes an inlet 32 and an outlet 34, each coupled to the first conduit assembly 18. The inlet 32 receives the oil pumped by the first pump 20. The oil cooler 22 is adapted to exchange heat with the oil flowing therethrough, for example, during working of the HEUI system 10, the oil gets heated and surplus heat from HEUI system 10 needs to be removed before it is introduced in the HEUI pump 12, in such a case the oil cooler 22 exchanges heat from the oil in order to cool the oil.

The first conduit assembly 18 further includes the primary filter 24 coupled to the first conduit assembly 18 and disposed downstream of the oil cooler 22. The primary filter 24 includes an inlet 36 and an outlet 38, the inlet 36 receives the oil after heat is exchanged with the oil by the oil cooler 22. During working of the HEUI system 10, the oil passes through the primary filter 24 and exits the primary filter 24 through the outlet 38. After passing through the outlet 38 of the primary filter 24, the oil flows through the first conduit assembly 18 and reaches a secondary filter 40 disposed downstream of the first conduit assembly 18. The secondary filter 40 includes an inlet 42 and an outlet 44. The secondary filter 40 receives the oil from the first conduit assembly 18 at the inlet 42 and filters the oil. The filtered oil flows through the outlet 44 of the secondary filter 40 and is received at an inlet 46 of the HEUI pump 12. As shown in the FIG. 1, the HEUI pump 12 is disposed downstream of the secondary filter 40, and the inlet 46 of the HEUI pump 12 is coupled to the outlet 44 of the secondary filter 40 thereby, enabling a fluid communication between the first conduit assembly 18 at a second end 48 of the of the first conduit assembly 18.

The HEUI pump 12 further pumps the oil received into a second conduit 50, which coupled to an outlet 52 of the HEUI pump 12 and is in fluid communication with the HEUI pump 12. The second conduit 50 is coupled to an oil manifold 54, and therefore, the oil pumped by the HEUI pump 12 reaches the oil manifold 54. The oil manifold 54 is operably connected to unit injectors 56, and the oil flowing through the second conduit 50 is used for operating the Unit injectors 56 for injecting the fuel. The details of the operation of the unit injectors 56 is known to one skilled in art and therefore, is not described in detail. Also, the HEUI system 10 further includes various other components, such as, a fuel tank, a water separator, a fuel pressure regulator, a fuel filter, Electronically Controlled Module etc. For the purpose of simplicity, the various components of the HEUI system 10 are not shown in FIG. 1. Further, the primary conduit 18 is in fluid communication with a third conduit 58 which is adapted to supply the oil to the engine, the details of which are not discussed for the sake of simplicity.

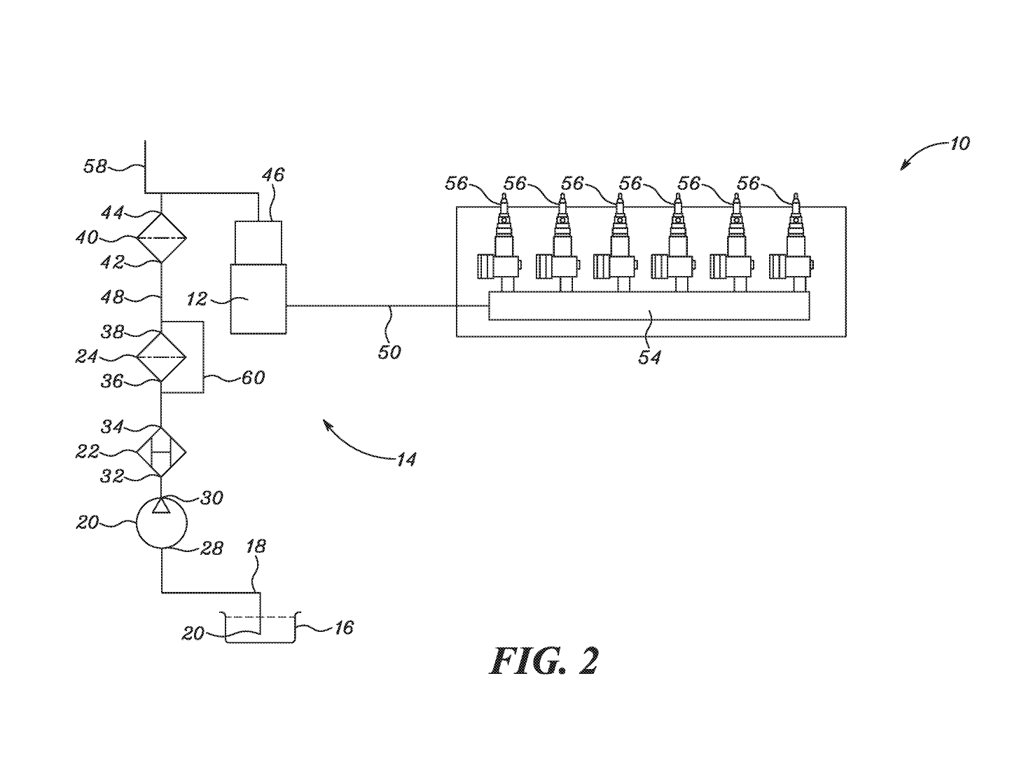

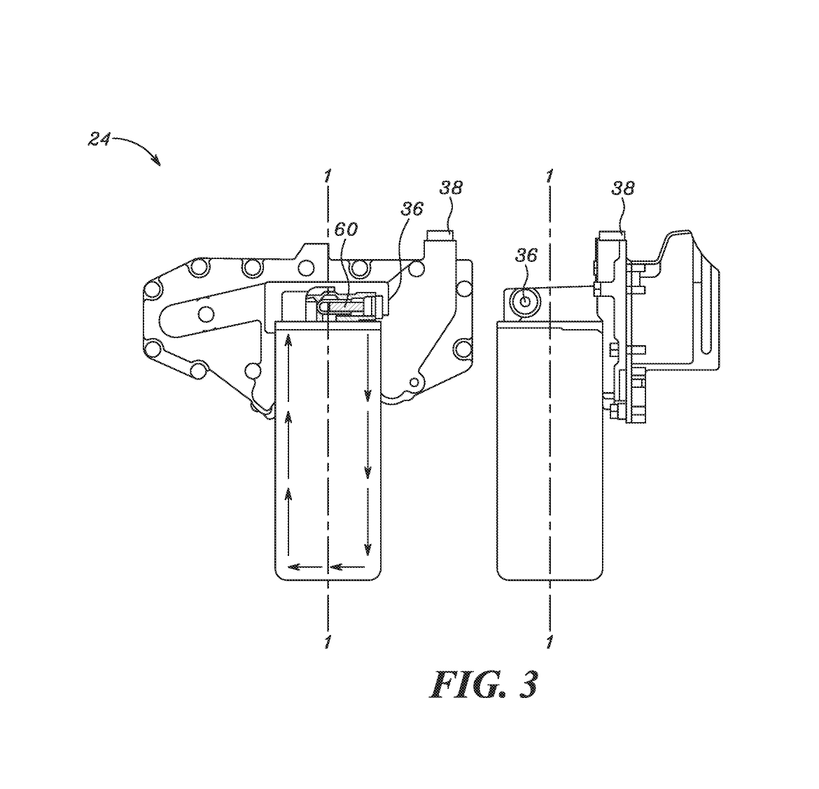

Referring to FIG. 2 and FIG. 3, a schematic diagram of the oil filtration system 14 of the HEUI system 10 and the primary filter 24 is shown, according to the concepts of the present disclosure. As disclosed above, the oil contained in the oil source 16 is pumped by the first pump 20, finally reaching the inlet 36 of the primary filter 24. However, during cold start conditions, i.e. when the HEUI system 10 is operating in low temperature conditions, the oil is highly viscous and therefore, cannot pass through the primary filter 24. In such a condition, a bypass conduit 60 is provided within the primary filter 24. The bypass conduit 60 is disposed in parallel configuration with the primary filter 24, and is adapted to provide a bypass path for flow of the oil therethrough, thereby preventing the flow of the oil through the primary filter 24. The bypass conduit 60 requires a predetermined pressure to open the bypass conduit 60 for allowing the oil to flow therethrough. This is enabled by an increasing pressure built-up of the oil pumped by the first pump 20, as the oil is unable to pass through the primary filter 24 due to increased viscosity. The pressure built-up finally reaches the predetermined pressure, thereby, opening the bypass conduit 60.

Upon opening of the bypass conduit 60, the oil reaches the inlet 42 of the secondary filter 40. As shown, the secondary filter 40 is coupled downstream to both the first conduit assembly 18 and the bypass conduit 60, and is disposed upstream of the HEUI pump 12. The secondary filter 40 filters the oil before the oil is introduced in the HEUI pump 12. In an embodiment, the bypass conduit 60 is a bypass valve designed to open at the predetermined pressure thereby enabling the oil to bypass the primary filter 24 and reach the HEUI pump 12 under the cold start conditions.

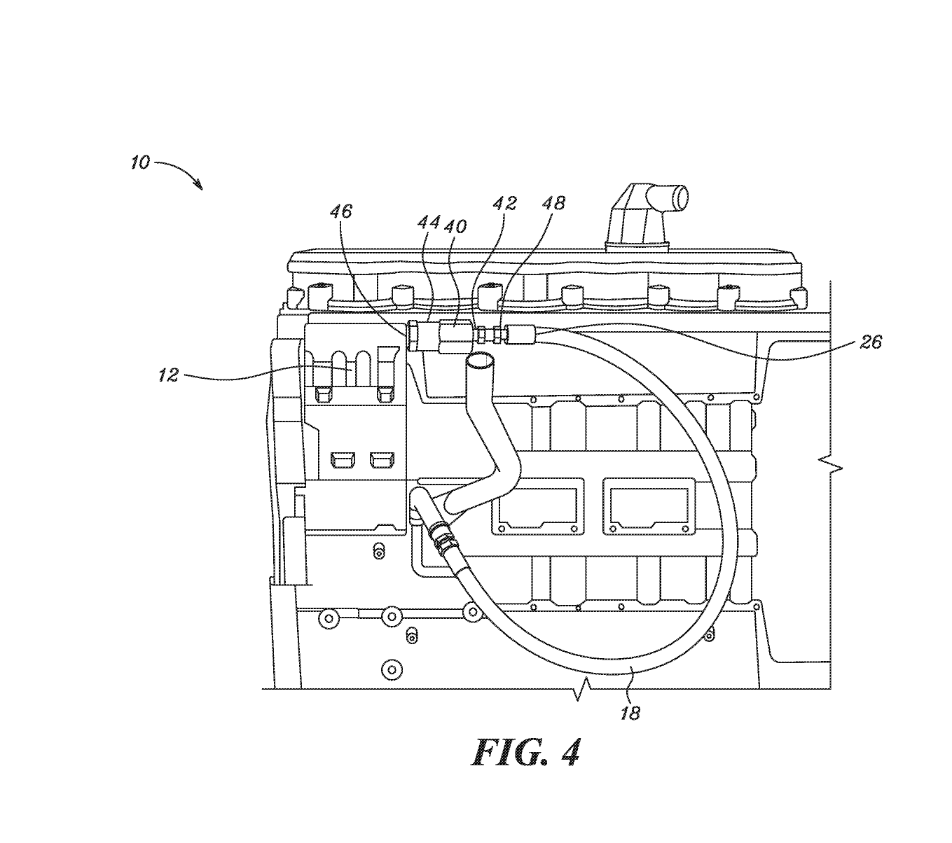

FIG. 4 shows the HEUI system 10 including the HEUI pump 12 and the secondary filter 40 coupled at the inlet 46 of the HEUI pump 12, according to an embodiment of the present disclosure. As discussed above, the first conduit assembly 18 supplies the oil to the inlet 42 of the secondary filter 40, and the secondary filter 40 filters the oil which flows therethrough. The filtered oil flows through the outlet 44 of the secondary filter 40, and is received by the inlet 46 of the HEUI pump 12. It will be apparent to one skilled in art that although the secondary filter 40 is shown coupled to the inlet 46 of the HEUI pump 12, the secondary filter 40 may be disposed at any place in the first conduit assembly 18 upstream of the HEUI pump 12.

### INDUSTRIAL APPLICABILITY

Internal combustion engine equipped with Hydraulically actuated Electronically controlled Unit Injector (HEUI) system use a lubrication system or any other hydraulic fluid system in order to operate Unit injectors for injecting fuel into the Internal combustion engine. Typically, the lubrication system includes an oil tank which supplies oil to a HEUI pump, which further pumps the oil for operating the Unit Injectors.

The present disclosure provides the secondary filter 40 for filtering the oil used in the HEUI system 10. Under cold start conditions, the oil in the first conduit assembly 18 bypasses the primary filter 24 through the bypass conduit 60 in order to reach the HEUI pump 12. The bypass conduit 60 is adapted to provide the bypass path for the flow of the oil therethrough, thereby preventing the flow of the oil through the primary filter 24. The secondary filter 40 is coupled downstream to both the first conduit assembly 18 and the bypass conduit 60, and upstream of the HEUI pump 12, therefore, is able to remove the debris even under cold start conditions which the primary filter 24 is bypassed. The secondary filter 40 helps in reducing the wear in the HEUI pump 12 and the unit injectors 56, in turn reducing downtime and the need for servicing the HEUI pump 12 and the unit injectors 56.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. An oil filtration system for a Hydraulically actuated Electronically controlled Unit Injector (HEUI) pump, the oil filtration system, comprising:
an oil reservoir;
a first conduit assembly having a first end and a second end, the first conduit assembly being in fluid communication with the oil reservoir at the first end, and the first conduit assembly being in fluid communication with the HEUI pump at the second end, the first conduit assembly including,
a first pump coupled to the first conduit assembly, the first pump disposed downstream of the oil reservoir, wherein the first pump is adapted to pump oil from the oil reservoir to the first conduit assembly;
a primary filter coupled to the first conduit assembly, the primary filter disposed downstream of the first pump;
a bypass conduit disposed in parallel configuration with the primary filter, the bypass conduit adapted to provide a bypass path for flow of oil therethrough, thereby preventing flow of oil through the primary filter; and
a secondary filter coupled downstream to both the first conduit assembly and the bypass conduit;
wherein the secondary filter is disposed upstream of the HEUI pump.
